(19) United States
(12) Patent Application Publication
(10) Pub. No.: US 2005/0220673 A1
(43) Pub. Date: Oct. 6, 2005

(54) Sensor comprising an array of pieroresistors

(76) Inventor: Jacob Thaysen, Copenhagen (DK)

Correspondence Address: JACOBSON HOLMAN PLLC, 400 SEVENTH STREET N.W., SUITE 600, WASHINGTON, DC, 20004, US

(21) Appl. No.: 10/505,554

(22) PCT Filed: Feb. 21, 2003
(86) PCT No.: PCT/DK03/00117

§ 371 Date: Aug. 23, 2004

Related U.S. Application Data
(60) Provisional application No. 60/366,243, filed on Mar. 22, 2002.

(30) Foreign Application Priority Data
Feb. 22, 2002 (DK) PA 2002-00283

(51) Int. Cl. G01N 27/00

(52) U.S. Cl. 422/98

(57) ABSTRACT

The invention relates to a sensor comprising at least 3 sensor units arranged in one or more rows of sensor units. Each sensor unit comprises a piezoresistor and wires for applying a voltage over the piezoresistor. The sensor units of the row is connected to each other via a sensor unit row connection wire whereto the first supply wire is connected. The second supply wire is connected to one or more basis resistors. One or more of the sensor units comprise an output wire for measuring an output signal. The output wire is connected to the sensor unit via the sensor-resistor wire connecting the sensor unit and the one or more basis resistors. By the present invention it is possible to configure the sensor unit array such that it is possible to multiplex the signal and thereby get in contact with each single array element by only having one electrical wire per row and column, where column indicates the number of sensors per row. By multiplexing the supply voltage on the rows and ground potential on the columns, it is possible to obtain signals from all the sensor units, either one by one or in rows of sensor units simultaneously.

### THE FIELD OF THE INVENTION

The present invention relates to a sensor comprising at least 3 sensor units, wherein each sensor units comprises a piezoresistor and wires connected to sensor unit for applying a voltage over the piezoresistor.

### BACKGROUND OF THE INVENTION

Sensors of the above type are well known from the literature. In the literature such sensors are also designated “micro sensors”, as they are often of micrometer dimensions. Examples of known sensors include gas sensors e.g. as described in “smart single-chip gas sensor microsystem”, C. Hagleitner et al., Nature 414, November 15^{th}, 2001, 293-296, and EP patent publication No. 72 744; AFM probes as described in “5×5 2D AFM cantilever arrays a first step towards a Terabit storage device”, M Lutwyche et al, Sensor and Actuators 73 (1999) 89-94; and liquid sensors as described in WO 00/66266.

From stress formation studies in ambient and aqueous environments, micrometer-sized cantilevers with optical read-out have proven very sensitive as described in the articles Berger, R., Gerber, Ch., Lang, H. P. & Gimzewski, J. K. Micromechanics: A toolbox for femtoscale science: “Towards a laboratory on a tip”. Microelectronic Engineering. 35, 373-379 (1997), and O'Shea, S. J., Welland, M. E. Atomic force Microscopy stress sensors for studies in liquids. J. Vac. Sci. Technol. B. 14, 1383-1385 (1996).

A particularly promising application is for detection of molecular interaction, where capture molecules are immobilized on the surface of the cantilever. A surface stress is induced when target molecules bind to the capture molecules on the cantilever. The surface stress change obtained due to the molecular interaction can be detected by integrating a stress sensitive piezoresistor into the cantilever. By integrating the piezoresistor in a Wheatstone bridge, the resistance change due to the surface stress change is transformed into a change in voltage. Other types of mechanical sensors that are sensitive to surface stress include micro bridges and membranes. In the following the bio-chemical mechanical sensor with an integrated piezoresistor is called BCMS.

Basically, a biochemical reaction at the cantilever surface can be monitored as a bending or stretch of the cantilever due to a change in the surface stress. Surface stress changes in self-assembled alkanethiols on gold have earlier been measured in air by this technique, and surface stress changes of approximately 10⁻⁵ N/m can be resolved by cantilever-based methods. This sensor principle has a wide range of applications in the detection of specific biomolecules as well as in real time local monitoring of chemical and biological interactions.

Cantilever-based sensors with integrated piezoresistive read-out are described by Thaysen, J., Boisen, A., Hansen, O. & Bouwstra, S. AFM probe with piezoresistive read-out and highly symmetrical Wheatstone bridge arrangement. Proceedings of Transducers '99, 1852-1855 (Sendai 1999). Hereby the stress changes on the cantilever sensors can be registered directly by the piezoresistor. Moreover, integrated read-out greatly facilitates operation in solutions since the refractive indices of the liquids do not influence the detection. Each sensor has a built-in reference cantilever, which makes it possible to subtract background drift directly in the measurement. The two cantilevers are connected in a Wheatstone bridge, and the stress change on the measurement cantilever is detected as the output voltage from the Wheatstone bridge.

Detecting different target molecules in one sample simultaneously can be obtained by incorporating more sensor units e.g. BCMS on the same chip and then expose all of the sensor units to the sample. In case of biochemical detection, different capture molecules may be immobilized on each BCMS, which binds specifically to one target molecule. For example, DNA molecule 1 binds only to BCMS A and DNA molecule 2 binds only to BCMS B, etc. Other molecules can be: proteins, antigen, antibodies, ligands, etc. By monitoring the signal from each BCMS, it is possible to determine if a specific target molecule is expressed in the sample and also the concentration of the target molecule.

When using direct read-out, the number of electrical wires on a sensor, which consists of an array of sensor units, is rapidly increased.

Usually, the Wheatstone bridge configuration is set up such that it consists of two piezoresistors each placed on a sensor unit, and two resistors placed on the substrate. This configuration can be seen on FIG. 1. One of the sensor units is then used as a measurement unit while the other sensor unit is used as a reference.

Alternatively each sensor unit may be connected to half a Wheatstone bridge, in which situation the need of electrical connections to each sensor unit is 3. If a whole Wheatstone bridge is configured on the chip with one or two sensor units, the requirement to the electrical connections is 2 or 4 per sensor unit.

A sensor comprising a large number of sensor units would therefore need an even larger number of wires for direct read-out. This required number of wires generally takes up a large space and therefore limits the number of sensors which can be applied on a sensor e.g. in the form of a chip.

A sensor containing 100 sensor units/resistors would thus at least require 200 wires. Since only half of the sensor units/resistors are used for measuring while the other half is used as references, it is seen that only 50 measurements can be performed on such a sensor.

### SUMMARY OF THE INVENTION

The objective of the invention is to provide a sensor comprising an array of piezoresistor sensor units for direct read-out, wherein the space needed for wiring is reduced.

Another objective of the present invention is to provide a sensor comprising an array of piezoresistor sensor units, for direct read-out wherein the use of the wires is more effective than according to prior art techniques.

Yet a further objective is to provide a sensor wherein the number of sensor units on a sensor of a given size may be increased.

These and other objectives have been achieved by the invention as defined in the claims.

### DISCLOSURE OF THE INVENTION

The sensor according to the invention comprises an array of sensor units, which in the present invention means at least 3 sensor units.

The sensor may preferably comprise at least 10 sensor units, more preferably at least 50 sensor units.

The sensor units each comprise a stress sensitive piezoresistor. The piezoresistor is denoted “a stress sensitive piezoresistor” because the piezoresistor is a part of the sensor unit where the sensor unit is capable of being deflected or stretched due to stress generated on its surface. By this deflection/stretch the piezoresistor will be deformed, which changes its resistivity. The piezoresistor may be any kind of resistor with the ability of changing resistivity due to a deformation provided by deflecting and/or stretching of the sensor unit. Piezoresistors are well known in the art and are e.g. described in the following publications which are hereby incorporated by reference: U.S. Pat. No. 6,237,399, U.S. Pat. No. 5,907,095, Berger, R. et al. Surface stress in the self-assembly of alkanethiols on gold. Science. 276, 2021-2024 (1997); Berger, R., Gerber, Ch., Lang, H. P. & Gimzewski, J. K. Micromechanics: A toolbox for femtoscale science: “Towards a laboratory on a tip”. Microelectronic Engineering. 35, 373-379 (1997); Thaysen, J., Boisen, A., Hansen, O. & Bouwstra, S. AFM probe with piezoresistive read-out and highly symmetrical Wheatstone bridge arrangement. Proceedings of Transducers '99, 1852-1855 (Sendai 1999); Boisen A., Thaysen J., Jensenius H., & Hansen, O. Environmental sensors based on micromachined cantilevers with integrated read-out. Ultramicroscopy, 82, 11-16 (2000).

Preferred piezoresistors include piezoresistors of a material selected from the group consisting of polysilicon, single crystalline silicon, metal or metal containing composition e.g. gold, AlN, Ag, Cu, Pt and Al, conducting polymers such as doped octafunctional epoxidized novalac e.g. doped SU-8.

The array of sensor units includes at least one row of sensor units. As will be described below, the sensor unit may advantageously contain several rows of sensor units.

The sensor comprises a first and a second supply wire. One or both supply wires are connected to a power source.

In one embodiment, one of the supply wires, preferably the first supply wire, is connected to a power source and the other one, preferably the second supply wire, is connected to the ground. Thereby a voltage can be applied over the sensor and its sensor units. The skilled person knows that this may be varied. The important thing is that the supply wires should be able to apply a voltage over the sensor units and thereby over the piezoresistors of the sensor units.

In the sensor according to the invention one or more, preferably all of the sensor units of one row, are connected to each other via a sensor unit row connection wire, the first supply wire being connected to the sensor unit row connection wire. Thereby power is applied to all the sensor units of the row using one supply wire.

The second supply wire may preferably be connected to a resistor row connection wire. The resistor row connection wire is connected to the sensor units of the first row via one or more basis resistors, and thereby a voltage may be applied over the sensor units and the basis resistors. The respective wires connecting a sensor unit to one or more basis resistors are designated sensor-resistor wires.

In one embodiment, the one or more basis resistors are directly connected to the second supply wire or wires.

The term “basis resistors” designates resistors which are not sensor units and do preferably not comprise a piezoresistor. It is generally preferred that the basis resistors have a constant resistivity, i.e. a resistivity which is not changing during the measurement. In one embodiment, the basis resistors are resistors with known resistance. The calculation of the voltage drop or relative voltage drop over the sensor units may be performed using the general principle based on Ohm's law.

One or more of the sensor units comprise an output wire for measuring an output signal. The output wire of the respective sensor unit is connected to the sensor-resistor wire, e.g. between the sensor and the resistor, optionally so that the output signal is measured at a wire connected directly to the sensor unit with no other resistors in between. In case there is a resistor between the sensor unit and the output wire connected thereto, the resistance of this resistor may preferably be known.

By use of this output wire the voltage drop over the respective sensor units may be measured. Thus, it is preferred that at least two sensor units of a row comprise an output wire, and that these output wires are arranged so in relation to each other that it is possible to measure the difference in voltage drop over the two sensor units. In this embodiment it is desired that the basis resistors have equal resistivity.

Alternatively the output wire or wires may be arranged so in relation to the first or the second supply wires that it is possible to measure the difference in voltage drop over the sensor unit.

If the sensor comprises one row of sensor units, it is preferred that each sensor unit is connected to a basis resistor. In one embodiment, several sensor units are connected to the same basis resistor. In another embodiment each sensor unit is connected to “its own” basis resistor.

In one preferred embodiment, the sensor comprises one row of sensor units including x sensor units wherein x is an integer of 3 or larger, and one row of basis resistors comprising x basis resistors: the sensor units and the basis resistors are connected to each other in pairs, i.e. one sensor unit/basis resistor pair consists of one sensor unit and one basis resistor. The sensor units are connected to each other via a sensor row connection wire whereto the first supply wire is also connected, and the basis resistors are preferably connected to each other via a resistor row connection wire, whereto also the second supply wire is connected. An output wire may preferably be connected to each sensor unit/basis resistor pair, i.e. the output wire of each pair is connected to the wire connecting the sensor unit to the basis resistor.

For sensors having more than 6 sensor units it may be appropriate that the sensor units are arranged in more than one row. As it is often desired to have as many sensor units as possibly on a sensor with a given size, it is generally preferred that the sensor comprises two or more rows of sensor units, such as at least 5, more preferably between 6 and 12 rows of sensor units.

The sensor may preferably further comprise a row of basis resistors, preferably including 2 or more basis resistors with identical resistance.

Each row of sensor units and basis resistors may preferably comprise at least 3, preferably at least 10, more preferably between 25 and 50 sensor units and basis resistors, respectively.

The sensor units in a row may preferably be placed one after the other in a line which is preferably straight, i.e. the front and the rear of the sensor units defined as the respective ends of the piezoresistor are placed in straight lines +_{—} 10%, such as about 5% or less of the length of the respective piezoresistors. The length of the piezoresistors, measured as the distance along the piezoresistor from one of its ends to the other, may preferably be the same +_{—} 10%, such as about 5% or less for all of the piezoresistors.

The rows of sensor units may preferably be placed substantially parallel to each other, i.e. the straight lines are substantially parallel which includes an angle deviation of +_{—} 10°, such as about 5° or less, wherein 1° is 1/360 of a circle.

It is preferred that each of the rows of sensor units comprises a sensor unit row connection wire. The sensor unit row connection wires may preferably be arranged so in relation to the first supply wire that the first supply wire may be connected in turn to the respective sensor unit row connection wires.

In order to obtain a measurement from as many of the sensor units as possible it is preferred that each of the sensor units is connected to a diode. The diode should preferably but not necessarily be connected directly to the sensor unit with no other resistors in between the sensor unit and the diode. If there is a resistor between the diode and the sensor unit, it is preferred that the resistance of the resistor is known, in other word, the resistance of this resistor should not change during the measuring using the sensor. The diode should preferably be connected to the sensor unit via the wire connecting the sensor unit to the second supply wire.

In a sensor comprising two or more rows of sensor units, each sensor unit may preferably be connected to a sensor unit row connection wire and a sensor unit cross connection wire. A sensor unit cross connection wire is defined as a wire connected to at least two sensor units and at the most one sensor unit from each row. Thereby each sensor unit row connection wire may be connected to each sensor unit cross connection wire in one connection via a sensor unit. This connection wire matrix is in the following designated a connection wire matrix.

For a sensor comprising a connection wire matrix it is preferred that the diode for each sensor is placed on one of the wires connecting the respective sensor unit to the sensor unit connection wire and the sensor unit cross connection wire, respectively. Preferably the diode for each sensor is placed on the wire connecting the respective sensor unit to the respective sensor unit cross connection wire.

It is generally desired that connections of the connection wire matrix are arranged so that the diodes guide the current through the sensor units connected directly, and with no other sensor units in between, to the sensor unit row connection wire, whereto the first supply wire is connected and via the sensor unit cross connection wire and optional basis resistor to the second supply wire.

In a preferred embodiment of the sensor comprising a connection wire matrix, each sensor unit cross connection wire is linked to at least two sensor unit-diode pairs comprising one diode and one sensor unit. The diode allows the current to pass through the sensor in only one direction. Each sensor unit cross connection wire is further linked to the second supply wire via a basis resistor. Preferably the sensor unit cross connection wires are linked to the second supply wire via a resistor row connection wire connecting the respective basis resistors to each other.

The number of sensor units and basis resistors, respectively, in the respective rows may preferably be equal to each other. Thereby the number of sensor unit row connection wires is equal to the number of sensor unit rows, and the number of sensor unit cross connection wires is equal to the number of sensor units in each row. This connection wire matrix is designated a complete connection wire matrix.

The sensor units in the array can be placed with the same spacing as used in DNA chips, e.g. as described in U.S. Pat. No. 6,254,827, and an array of sensor units can straightforwardly be used in the same type of applications as in the DNA chip. The signal from DNA chips is today read-out by the use of rather bulky optical detector systems and fluorescently labeled molecules. The present invention makes it possible to realize an array with the same performance but with a simple electrical and label free detection scheme. The sensor units may e.g. be functionalised with the same array sputter techniques as used in DNA chip production. Any other method may be used, e.g. as described in WO 0066266, WO 9938007, U.S. Pat. No. 5,156,810, WO 0036419 and WO 9631557, which publications are hereby incorporated by reference.

The sensor unit may in principle be any type of flexible unit which is usable in connection with surface stress sensing elements. Generally, it is preferred that the sensor unit is a flexible sheet-formed unit having an average thickness smaller than both its average thickness and its average width. Such sensor units preferably include cantilevers, bridges and diaphragms. In principle, however, the sensor unit may also be shaped as a cord.

The thickness of the sensor unit may preferably be between 0.1 and 25 μm, more preferably between 0.3 and 5 μm, such as about 1 μm. The other dimensional parameters, thickness, width and or diameter, may preferably be up to about 500 μm, more preferably up to about 100 μm, such as about 50 μm.

In one embodiment, the sensor unit is a flexible sheet-formed unit with an average thickness of at least 5 times, preferably at least 50 times less than its average width, and/or the sensor unit is a flexible sheet-formed unit having an average thickness of at least 5 times, preferably at least 50 times less than its average length. As the sensor unit may have shapes with no unambiguous definition of width and length, e.g. rounded or circular shapes, it is generally preferred that such a sensor unit is in the form of a sheet-formed unit with an average thickness of at least 5 times, preferably at least 5 times less than its other dimensions including width, length and diameter. In case the sensor unit is of a rounded or circular shape, the following reference to width and length, respectively, means the shortest and the longest, respectively, diameter or stub diameter.

The term “flexible” used in relation to a sensor unit means that the sensor unit should be capable of deflecting and or being stretched, e.g. due to stress formed in the surface of the sensor unit.

When the sensor unit is deflecting or stretching the resistivity of the piezoresistor is changing, and thereby the piezoresistor is stress sensitive. By applying a voltage over the piezoresistor, e.g. in the range of 0.1 to 10 V such as about 5 V, the change of resistivity of the piezoresistor can be detected.

In one embodiment the sensor unit is a structure that protrudes from a substrate and is capable of being deflected, such as a deflection of 1 μm, due to a deflection force of 10⁻³ N or less, such as of 10⁻⁵ N or less, such as of 10⁻⁷ N or less, such as of 10⁻⁹ N or less, such as of 10⁻¹⁰ N or less, such as of 10⁻¹¹ N or less, such as of 10⁻¹² N or less, such as of 10⁻¹³ N or less, such as of 10⁻¹⁴ N or less, such as of 10⁻¹⁵ N or less.

The sensor unit may preferably have dimensions as described in PCTDK0300042, and WO 00/66266, which are hereby incorporated by reference.

The sensors may preferably be based on a material composition comprising one or more of the materials selected from the group consisting of silicon, silicon nitride, silicon oxide, metal, metal oxide, glass and polymer, wherein the group of polymers preferably includes epoxy resin, polystyrene, polyethylene, polyvinylacetate, polyvinylcloride, polyvinylpyrrolidone, polyacrylonitrile, polymethylmetacrylate, polytetrafluoroethylene, polycarbonate, poly-4-methylpentylene, polyester, polypropylene, cellulose, nitrocellulose, starch, polysaccharides, natural rubber, butyl rubber, styrene butadiene rubber and silicon rubber.

Particularly preferred materials for the sensors include compositions comprising an epoxy resin, preferably selected from the group consisting of epoxy functional resin having at least two epoxy groups, preferably an octafunctional epoxidized novalac.

The sensor units may be integrated in the substrate carrying several or all sensor units. The substrate carrying the sensors is in the following designated the primary substrate.

The primary substrate in connection with the sensor unit may in principle have any shape generally known in the art.

The primary substrate may in principle be of any type of material, such as one or more of the materials selected from the group consisting of silicon, silicon nitride, silicon oxide, metal, metal oxide, glass and polymer, wherein the group of polymers preferably includes epoxy resin, polystyrene, polyethylene, polyvinylacetate, polyvinylcloride, polyvinylpyrrolidone, polyacrylonitrile, polymethylmetacrylate, polytetrafluoroethylene, polycarbonate, poly-4-methylpentylene, polyester, polypropylene, cellulose, nitrocellulose, starch, polysaccharides, natural rubber, butyl rubber, styrene butadiene rubber and silicon rubber.

In order to have optimal processability, the primary substrate should preferably be of or comprise a material which can act as a photo resist. Preferred materials include an epoxy resin, preferably selected from the group consisting of epoxy functional resin having at least two epoxy groups, preferably an octafunctional epoxidized novalac. Particularly preferred materials are described in U.S. Pat. No. 4,882,245, which is hereby incorporated by reference. The most preferred material is the octafunctional epoxidized novalac which is commercially available from Celanese Resins, Shell Chemical, MicroChem Inc. under the tradename SU-8, and from Softec Microsystems under the tradename SM10#0.

Basically, it is preferred that the sensor units are based on a material included in the primary substrate or preferably based on the same material as that of the primary substrate. If the sensor unit and the primary substrate are made in one piece, it is naturally based on the same material, but the sensor unit and the primary substrate may include one or more layers of material not included in the other part. To be based on a material means in the invention that at least 75%, preferably at least 90% by volume is constituted by this material.

If the sensor unit and the primary substrate are made in separate pieces and connected afterwards, the materials should at least be compatible with each other, and preferably the major weight part of the materials should be identical.

The wires connecting the sensor units to the other elements should preferably be integrated in the primary substrate e.g. as described in PCTDK030042, which is hereby incorporated by reference. For applications in liquid, the wires need to be insulated, and the primary substrate should therefore preferably consist of or comprise an electrically insulating material which prevents short-circuiting of the electrical connections during operation. The insulating material could e.g. be a polymer, silicon nitride, silicon oxide, metal oxides, etc. In case the electrical connection line includes doped silicon, the insulating property can be obtained by reversed biased diode effect. For a wire consisting of p-type silicon, the reversed biased diode effect is obtained by encapsulating the wire in n-type silicon. For applications in liquid, the piezoresistor should be integrated or embedded in the material of the respective sensor unit.

The sensor units may preferably be in the form of “free hanging sensor unit element” as defined in PCTDK0300042.

The sensor may preferably comprise a primary and a secondary substrate. It is preferred that the major part (more than 50% by number), preferably more than 95% by number, more preferably all of the sensor units, is integrated with the primary substrate, or alternatively fixed to the primary substrate.

The second substrate may comprise some of the components for providing the circuit including one or two wires for applying the voltage. By providing the sensor in parts including a primary substrate and a secondary substrate, the production of the sensor may be very simple and cost effective. Furthermore the secondary substrate may be mass-produced as it may be designed so that it can be used with different types of first substrates.

The secondary substrate may e.g. be an electronic chip comprising contact pads corresponding to wire connection points exiting from the first substrate.

In one embodiment, one or more basis resistors are fixed to the second substrate.

The primary and the secondary substrate may e.g. be connected to each other so that they may be disconnected again after end use. Thereby the secondary substrate may be reused.

In a preferred embodiment, one or more of the sensor units comprise an output wire for measuring an output signal. The output wire is connected to the sensor unit via the wire connecting the sensor unit to the second supply wire, and the secondary substrate comprises a circuit or wires for a circuit for measuring the difference in voltage drop over the sensor units. Thereby one of the sensor units may be used as reference e.g. as described in WO 00/66266, PCTDK0200779 and PCTDK0300042, which are hereby incorporated by reference.

The sensor may preferably be in the form of a microchip.

The sensor may preferably comprise at least one fluid channel, and at least one of the sensor units, preferably several or at least 95% by number of the sensor units, protrudes into at least one fluid channel. The fluid channel may e.g. be as disclosed in WO 9938007 and WO 0066266. The fluid channel may preferably be in the form of a channel for liquid, such as e.g. a flow channel. This can e.g. be used in micro liquid handling systems.

The sensor may preferably comprise at least one fluid channel for every two rows of sensor units.

As also described in WO 0066266, the fluid channel may include an interaction chamber, and the sensor units e.g. in the form of free hanging sensor unit element may preferably be integrated into the wall of said interaction chamber.

The sensor may be in the form of a microchip, which means that none of its dimensions should exceed 10000 μm, preferably none of its dimensions should exceed 5000 μm.

The sensor according to the invention may preferably comprise at least one sensor unit having a target surface area, which area has been functionalised by linking, preferably by covalently linking of one or more functional groups comprising a detection ligand to said target surface area, said detection ligand being a member of a specific binding pair. Further information relating to this aspect can be found in WO 0066266 and PCTDK0200779, which are hereby incorporated by reference. From these publications information relating to reference units can also be found.

It is thus preferred that the sensor comprises at least two sensor units, at least one of said sensor units being a reference unit. The reference unit may preferably comprise a target surface area, which area has a surface chemistry which is different from the sensor unit for which the reference unit acts as reference, preferably said target surface area has been functionalised by linking, preferably by covalently linking of one or more functional groups, wherein said one or more functional groups linked to the surface area of said reference unit or its concentration are different from the sensor unit for which the reference unit acts as reference.

The sensor according to the invention may preferably be used for detection of substances in gasses or liquids, preferably in liquids wherein the substances include biomolecules such as RNA oligos, DNA oligos, PNA oligos, protein, peptides, hormones, blood components, antigen and antibodies.

The sensor may be produced using any technology known in the art and e.g. as described in the publications, patents or patent applications referred to above. Particular reference is made to WO 00/66266, PCTDK0300042 and “CMOS-based microsensors and packaging”, Henry Baltes et al, Sensors and Actuators A 92 (2001) 1-9; which are hereby incorporated by reference.

The sensor could be bonded to external electrical circuits using flip-chip technology, e.g. as described in U.S. Pat. No. 6,254,827, which is hereby incorporated by reference.

### BRIEF DESCRIPTION OF DRAWINGS

FIG. 1 is a schematic illustration of a Wheatstone bridge configuration.

FIG. 2 is a schematic illustration of the circuit of a sensor according to the invention.

FIG. 3 is a variation of the schematic illustration shown in FIG. 2.

FIG. 4 is a schematic illustration of the circuit of another sensor according to the invention.

### DETAILED DESCRIPTION OF DRAWINGS

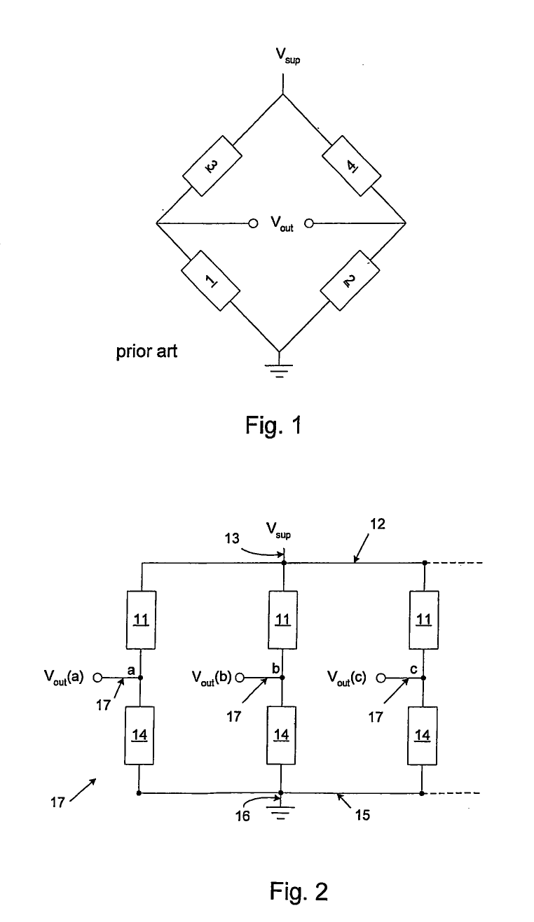

FIG. 1 is a schematic illustration of a Wheatstone bridge configuration used in the prior art technology for direct read-out from micro sensors e.g. as described in WO 00/66266. The Wheatstone bridge comprises four resistors 1, 2, 3, 4, and it can be incorporated into the sensor so that two of the resistors 1,2 are known basis resistors and the other two are sensor units, one of them e.g. as a reference sensor unit.

FIG. 2 is a schematic illustration of the circuit of a sensor according to the invention. The sensor comprises a first row of sensor units 11 connected to each other via a sensor unit row connection wire 12. The sensor unit row connection wire 12 is further connected to a first supply wire 13, which in this embodiment is the power supply. The sensor further comprises a row of basis resistors 14, which in this embodiment have resistances equal to each other. The basis resistors are connected to each other via a resistor row connection wire 15. The resistor row connection wire 15 is further connected to a second supply wire 16, which in this embodiment is the ground.

The sensor units 11 and the basis resistors 14 are connected to each other in pairs. An output wire 17 is connected to each sensor unit/basis resistor pair for measuring an output signal. The output wire of the respective sensor unit is connected to the sensor unit via the wire connecting the sensor unit to the basis resistor.

As seen in FIG. 2, all the sensor unit/basis resistor pairs constitute half Wheatstone bridges, which are connected with the same supply voltage and ground connection on-chip. In this set-up, the wire requirement is (n+2), wherein n is the number of sensor units in the row of sensor units.

The output signals from the half Wheatstone bridges can be connected as desired. For example, it is possible to only use one sensor unit as reference. By use of the output wire the voltage drop over the respective sensor units may be measured or calculated.

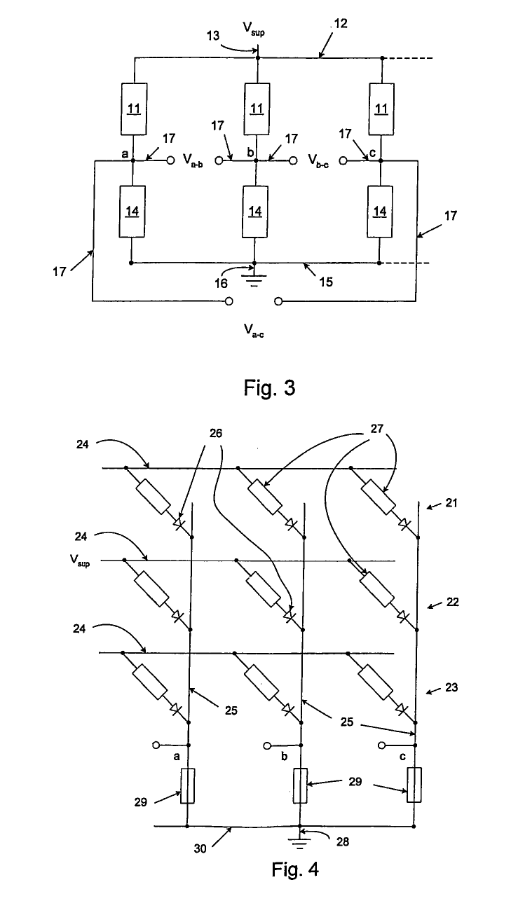

This is further indicated in FIG. 3. In this figure, the reference numbers have the same meaning as in FIG. 2. Here it can be seen that the output signals from the different half Wheatstone bridges can be compared.

It is also possible to multiplex externally such that the voltage drop from a-b, a-c, and b-c can be measured without changing the connections. The signal from the different half Wheatstone bridges can be compared either by a fixed configuration or by multiplexing the signals.

FIG. 4 is a schematic illustration of the circuit of another sensor comprising three rows of sensors indicated as the first row 21, the second row 22, and the third row 23.

The sensor comprises a complete connection wire matrix comprising three sensor unit row connection wires 24, one for each row, and three sensor unit cross connection wires 25, one for each sensor units in the respective rows. Each sensor unit cross connection wire 25 is linked to at least three sensor unit-diode pairs comprising one diode 26 and one sensor unit 27. The diode 26 allows the current to pass through the sensor 27 in only one direction. Each sensor unit cross connection wire 25 is further linked to the second supply wire 28 via a basis resistor 29. The sensor unit cross connection wires 25 are linked to the second supply wire 28 via a resistor row connection wire 30 connecting the respective basis resistors 29 to each other.

The first supply wire indicated Vsup may in turn be connected to the respective sensor unit row connection wires 24. Thereby the output from one sensor row after the other may be measured or calculated.

The output wires 31 are connected to the sensor unit cross connection wires 25.

For very large sensor unit arrays, such as BCMS arrays, even one electrical wire per sensor unit becomes both space consuming and expensive to connect to the external electronics. By the present invention it is possible to configure the sensor unit array such that it is possible to multiplex the signal and thereby get in contact with each single array element by only having one electrical wire per row and column, where column indicates the number of sensors per row. By multiplexing the supply voltage on the rows and ground potential on the columns, it is possible to obtain signals from all the sensor units, either one by one or in rows of sensor units simultaneously.

1. A sensor comprising an array of sensor units, each of the sensor units comprising a stress sensitive piezoresistor, the array of sensor units comprising at least one row of sensor units, the sensor comprising a first and a second supply wire for applying a voltage over the piezoresistors of the sensor units, the sensor units of the row being connected to each other via a sensor unit row connection wire, the first supply wire being connected to the sensor unit row connection wire, the second supply wire being connected to one or more basis resistors, said one or more of the sensor units comprising an output wire for measuring an output signal, said output wire being connected to the sensor unit via the sensor-resistor wire connecting the sensor unit and the one or more basis resistors.

2. A sensor according to claim 1 wherein said sensor comprises at least 3 sensor units, preferably at least 10 sensor units, more preferably at least 50 sensor units, said sensor including at least one row of sensor units having 3 or more sensor units.

3. A sensor according to claim 1 wherein the second supply wire is connected to a resistor row connection wire, said resistor row connection wire being connected to the sensor units of the row via the one or more basis resistors.

4. A sensor according to claim 1 wherein said output wire is connected to the sensor-resistor wire between the sensor and the resistor, preferably so that the output signal is measured at the sensor-resistor wire with the output wire connected directly to the sensor unit with no other resistors in between.

5. A sensor according to claim 1 wherein at least two sensor units of a row comprise an output wire, said output wire being arranged so that it is possible to measure the difference in voltage drop over the two sensor units.

6. A sensor according to claim 1 wherein at least one sensor unit comprises an output wire, said output wires being arranged so in relation to the first or the second supply wire that it is possible to measure the voltage drop over the sensor unit.

7. A sensor according to claim 1, said sensor comprising one row of sensor units, each sensor unit preferably being connected to a basis resistor.

8. A sensor according to claim 7 wherein said sensor units and said basis units constitute sensor-resistor pairs, said first and second supply wires preferably being arranged to apply the voltage over the sensor unit/basis resistor pairs, wherein each sensor unit/basis resistor pair preferably is in the form of a sensor unit and a basis resistor.

9. A sensor according to claim 1 wherein said sensor comprises two or more rows of sensor units, said row of sensor units preferably being placed substantially parallel to each other.

10. A sensor according to claim 9 wherein each of said rows of units comprises a sensor unit row connection wire, said sensor unit row connection wire preferably being arranged so that the first supply wire may be connected in turn to the respective sensor unit row connection wires.

11. A sensor according to claim 9 wherein each of said sensor units is connected to a diode, said diode being connected directly to the sensor unit with no other resistors in between the sensor unit and the diode.

12. A sensor according to claim 11 wherein each sensor unit is connected to a sensor unit row connection wire and a sensor unit cross connection wire, said sensor unit cross connection wire being linked to at least two sensor units and at the most one sensor unit from each row, the diode preferably being placed on one of the wires connecting the sensor unit to the sensor unit connection wire and the sensor unit cross connection wire, respectively.

13. A sensor according to claim 11 wherein the connections are arranged so that the diodes guide the current through the sensor units connected directly with no other sensor units in between, to the sensor unit row connection wire, whereto the first supply wire is connected and via the sensor unit cross connection wire and optional basis resistor to the second supply wire.

14. A sensor according to claim 11 wherein each sensor unit cross connection wire is linked to at least two sensor unit-diode pairs, the diode allowing the current to pass through the sensor in only one direction, each sensor unit cross connection wire further being linked to the second supply wire via a basis resistor, preferably said sensor unit cross connection wires is linked to the second supply wire via a resistor row connection wire connecting the respective basis resistors to each other.

15. A sensor according to claim 11 wherein the sensor comprises at least 3, preferably at least 5, more preferably between 6 and 12 rows of sensor units, said sensor preferably further comprising a row of basis resistors.

16. A sensor according to claim 8 wherein each row of sensor units and basis resistors comprises at least 3, preferably at least 10 more preferably between 25 and 50 sensor units and basis resistors, respectively.

17. A sensor according to claim 8, wherein the number of sensor units and basis resistors, respectively, in the respective rows is equal to each other.

18. A sensor according to claim 1 wherein said sensor units are flexible units selected from the group consisting of cantilevers, bridges and diaphragms.

19. A sensor according to claim 1 wherein said sensor units are flexible sheet-formed unit having an average thickness which is smaller than both its average thickness and its average width, the average thickness preferably being at least 5 times, more preferably at least 50 times less than its average width.

20. A sensor according to claim 1 wherein said piezoresistor comprises or preferably consists of a material selected from the group consisting of polysilicon, single crystalline silicon, metal or metal containing composition e.g. gold, AlN, Ag, Cu, Pt and Al, conducting polymers such as, doped octafunctional epoxidized novalac e.g. doped SU-8.

21. A sensor according to claim 20, said sensor being based on a material composition comprising an epoxy resin, preferably selected from the group consisting of epoxy functional resin having at least two epoxy groups, preferably an octafunctional epoxidized novalac.

22. A sensor according to claim 1 wherein said sensor comprises two or more basis resistors, said basis resistors having identical resistances.

23. A sensor according to claim 1 wherein said sensor comprises at least a primary and a secondary substrate, said sensor units being integrated with the primary substrate.

24. A sensor according to claim 23 wherein said second substrate comprises a wire for applying the voltage, said secondary substrate preferably being an electronic chip comprising contact pads corresponding to wire connection points exiting from the first substrate.

25. A sensor according to claim 23 wherein the one or more basis resistors are fixed to the second substrate.

26. A sensor according to claim 23 wherein one or more of the sensor units comprise an output wire for measuring an output signal, said output wire being connected to the sensor unit via the wire connecting the sensor unit to the second supply wire, said secondary substrate comprising a circuit or wires for a circuit for measuring the difference in voltage drop over the sensor units.

27. A sensor according to claim 1 wherein said sensor is in the form of a microchip.

28. A sensor according to claim 1 wherein said sensor further comprises at least one fluid channel, said sensor units protruding into at least one fluid channel.

29. A sensor according to claim 28 wherein each of said fluid channels includes an interaction chamber, said sensor units preferably being integrated into the wall of said interaction chamber or chambers.

30. A sensor according to claim 28 wherein said sensor comprises at least one fluid channel for every two rows of sensor units.

31. A sensor according to claim 1 wherein said sensor comprises at least one sensor unit having a target surface area, which area has been functionalised by linking, preferably by covalently linking of one or more functional groups comprising a detection ligand to said target surface area, said detection ligand being a member of a specific binding pair.

32. A sensor according to claim 1 wherein the sensor comprises at least four sensor units, at least one of said sensor units being a reference unit.
